(19) United States
(12) Patent Application Publication
(10) Pub. No.: US 2016/0003931 A1
(43) Pub. Date: Jan. 7, 2016

(54) AUTONOMOUS DIRECTION FINDING USING DIFFERENTIAL ANGLE OF ARRIVAL

(71) Applicant: KONINKLIJKE PHILIPS N.V., Eindhoven (NL)

(72) Inventors: STEPHEN LEDINGHAM, WALTHAM, MA (US); KLAAS CORNELIS JAN WIJBRANS, RIJEN (NL); PAVAN KOLAN REDDY, FRAMINGHAM, MA (US)

(21) Appl. No.: 14/770,307

(22) PCT Filed: Feb. 20, 2014
(86) PCT No.: PCT/IB2014/059105

§ 371 Date: Aug. 25, 2015

Related U.S. Application Data
(60) Provisional application No. 61/768,605, filed on Feb. 25, 2013.

(51) Int. Cl. G01S 3/38; G01S 5/06

(52) U.S. Cl. CPC G01S 3/38; G01S 5/06

(57) ABSTRACT

A system (10) and a method (150) track a tracking device (14). A radio frequency (RF) receiver (52) is configured to receive a periodic beacon signal originating at the tracking device (14). The periodic beacon signal is received with a directional antenna (36) at multiple bearings over time. An estimator (70) is configured to estimate a bearing to the tracking device (14) as the bearing of the multiple bearings in which a time of flight (ToF) of the periodic beacon signal is lowest. The RF receiver (52) can further be configured to simultaneously receive multiple instances of the periodic beacon signal with the directional antenna (36) at a bearing of the multiple bearings. In such instances, the RF receiver (52) is further configured to correlate the instances to identify which of the instances has a lowest ToF.

The present application relates generally to tracking. It finds particular application in conjunction with Alzheimer's patients, and will be described with particular reference thereto. However, it is to be understood that it also finds application in other usage scenarios, such as the tracking of goods, merchandise, materials, or vehicles, and is not necessarily limited to the aforementioned application.

Home health care tracking systems for wandering Alzheimer's patients allow the patients to be found once outside of their defined safe zones or geographical fences. When a patient leaves a corresponding safe zone or geographical fence, an alarm signal and/or tracking service is enabled. The alarm signal can, for example, trigger an alert, such as a cellular alert, to a care giver or a remote call center where a personal response assistant (PRA) directs the emergency. The tracking service can, for example, be based on cellular, global positioning system (GPS) or WiFi tracking. In some instances, the tracking service may be unavailable. For example, the patient may be outside cellular or WiFi coverage areas, or the patient may be in a low coverage area where the patient cannot be accurately located.

For such instances, a hand held direction finding (DF) device to allow a caregiver to autonomously locate an Alzheimer patient would be advantageous. However, no known home health care tracking systems currently include a DF device. Nonetheless, DF devices are known for other purposes. A DF device typically provides the user with an estimate of bearing to the target. Existing DF devices typically obtain an estimate of bearing using a directional antenna or an antenna array, and based on received signal strength indicator (RSSI) or Doppler shift employing. Further, the DF device typically provides the user with RSSI, which the user can employ to assess range to the target.

DF devices based on RSSI and Doppler shift are effective in open field environments where there are minimal multipath effects, but underperform in multipath environments, such as in and around buildings. Multipath is the phenomenon in which a radio signal reaches the receiver by two or more paths. Multipath can be caused by, for example, refraction and reflection of the signal from water bodies and terrestrial objects, such as mountains and buildings. The effects of multipath include constructive and destructive interference, and phase shifting of the signal. Hence, DF devices based on RSSI and Doppler shift result in false bearing and range estimates in multipath environments.

Existing DF devices (such as radar) based on time of flight (ToF), time of arrival (ToA), differential ToF (DToF), and angle of arrival (AoA) are also known. However, these DF devices have several disadvantages. For example, additional transmitters or transponders may be needed. As another example, complex and/or bulky antennas (such as high gain directional antennas) may be needed. As yet another example, bi-directional communications protocols requiring complex synchronization may be needed.

The present application provides a new and improved system and method which overcome these problems and others.

In accordance with one aspect, a system for tracking a tracking device is provided. The system includes a radio frequency (RF) receiver configured to receive a periodic beacon signal originating at the tracking device. The periodic beacon signal is received with a directional antenna at multiple bearings over time. The system further includes an estimator configured to estimate a bearing to the tracking device as the bearing of the multiple bearings in which a time of flight (ToF) of the periodic beacon signal is lowest.

The beacon signal can convey a packet comprising a frequency modulated preamble, a synchronization word and a unique identifier (ID). Additional fields can be added to the packet. For example, the packet can include a data payload, which can include telemetry data as a first approximation to last known position. Telemetry data can include elevation, GPS coordinates, WiFi media access control (MAC) addresses, and time. The WiFi MAC addresses could be used by a location service to locate routers and generate co-ordinates. The telemetry data could result in a significant reduction in search time by estimating a maximum error based on speed of wandering person.

In accordance with another aspect, a method for tracking a tracking device is provided. The method includes receiving a periodic beacon signal originating at the tracking device with a directional antenna at multiple bearings over time. The method further includes estimating a bearing to the tracking device as the bearing of the multiple bearings in which a time of flight (ToF) of the periodic beacon signal is lowest.

In accordance with another aspect, a system for tracking a tracking device is provided. The system includes a correlating radio frequency (RF) receiver configured to receive a periodic beacon signal originating at the tracking device. The periodic beacon signal is received with a directional antenna oriented at multiple bearing orientations over time. Further, multiple instances of the periodic beacon signal are simultaneously received at one of the antenna bearing orientations. The system further includes a processor configured to select the bearing orientation of the multiple bearing orientations associated with a lowest time of flight (ToF) of the periodic beacon signal. The ToF of the periodic beacon signal at the bearing orientation of the instances is a lowest ToF of the instances. Even more, the system includes a display device configured to display the selected bearing orientation to indicate a direction of the tracking device.

One advantage resides in reducing the probability of following the wrong beacon signal in multipath environments.

Another advantage resides in a more effective estimate of range and bearing in multipath environments.

Another advantage resides in improved range.

Another advantage resides in maximum allowable total radiated power (TRP).

Another advantage resides in spreading the signal over a wide bandwidth through the use of digital spreading, or spread spectrum, to take advantage in countries with regulations allowing for a greater transmitted equivalent isotropically radiated power (EIRP).

Another advantage resides in a simpler antenna design.

Another advantage resides in a unidirectional communication protocol.

Another advantage resides in reduced current consumption through use of a repetitive signal of short duration.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

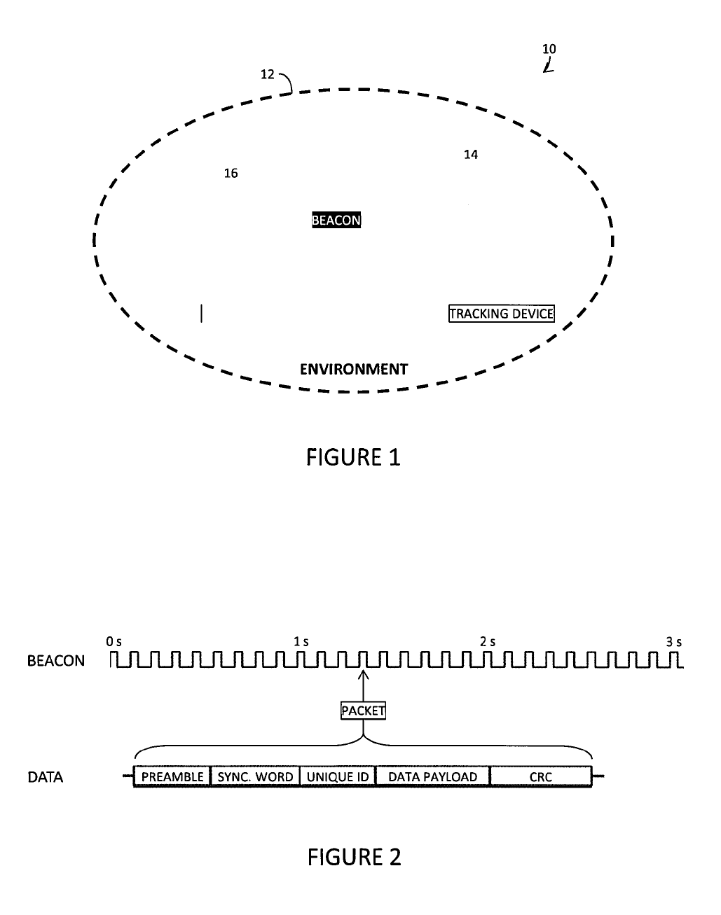

FIG. 1 illustrates a unidirectional tracking system including a tracking device and a direction finding (DF) device.

FIG. 2 illustrates a beacon signal transmitted from the tracking device to the DF device.

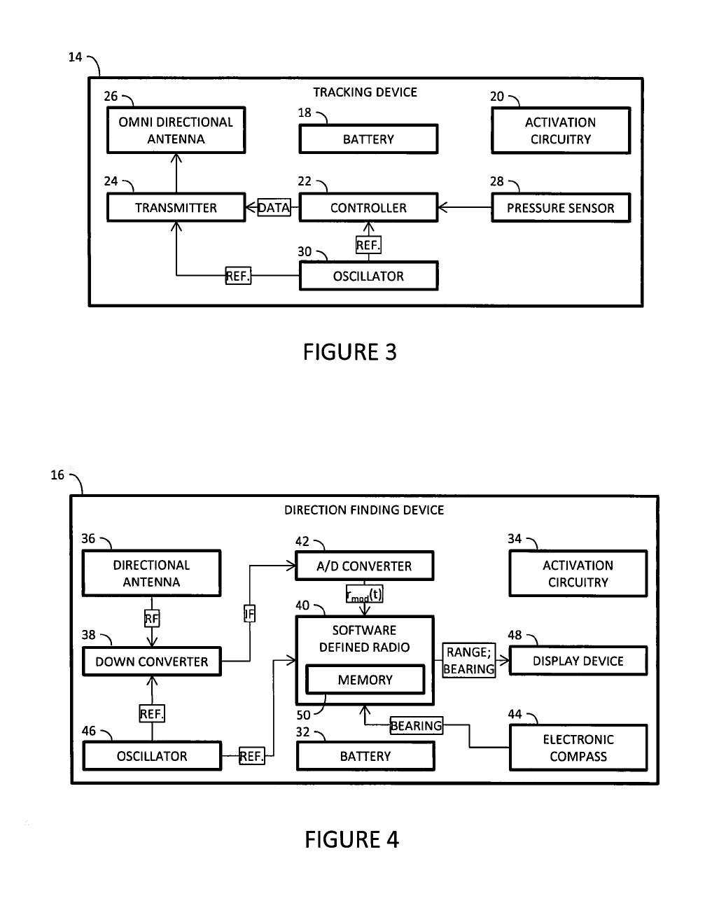

FIG. 3 diagrammatically illustrates the tracking device.

FIG. 4 diagrammatically illustrates the DF device.

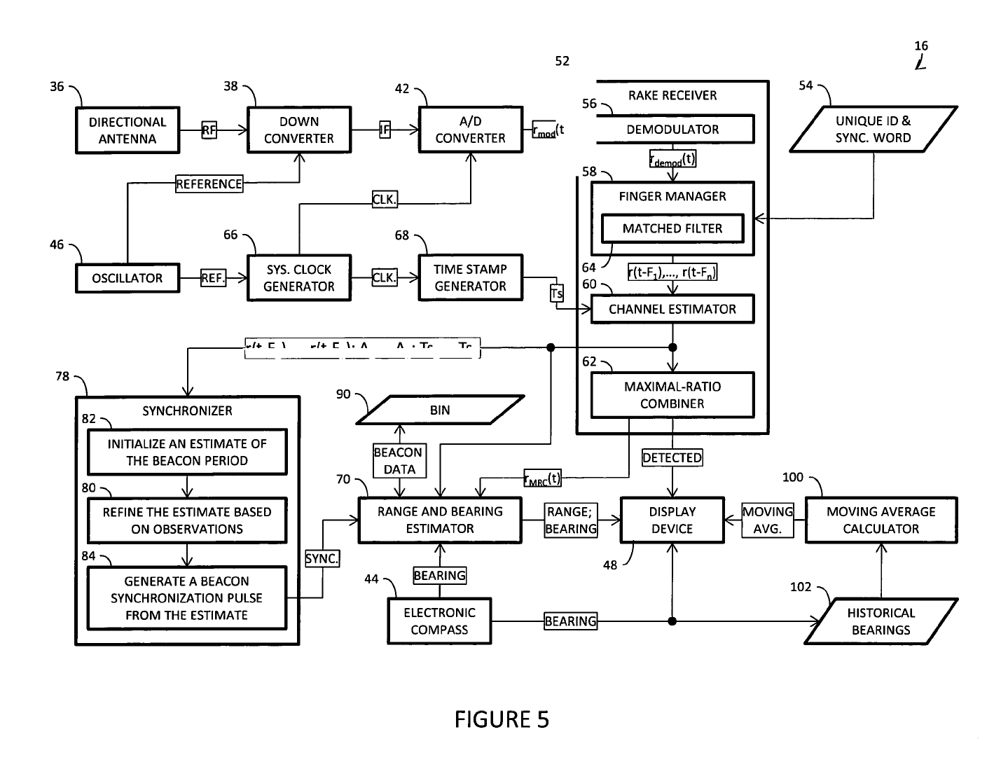

FIG. 5 provides a more detailed diagram of the DF device.

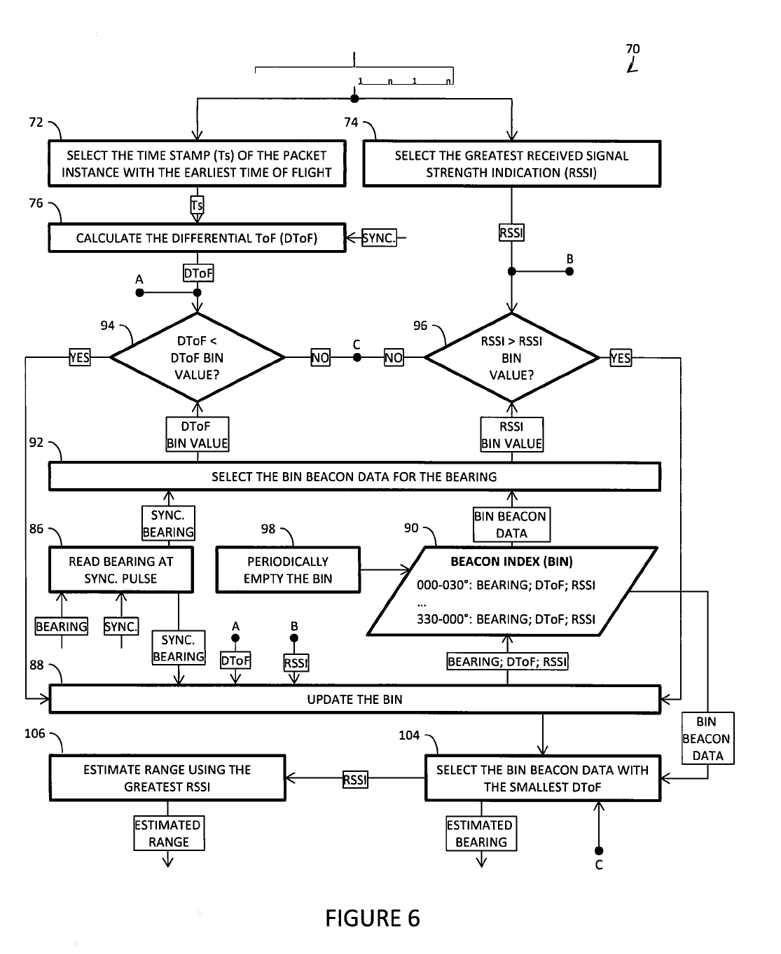

FIG. 6 illustrates a technique for estimating the range and the bearing from the DF device to the tracking device.

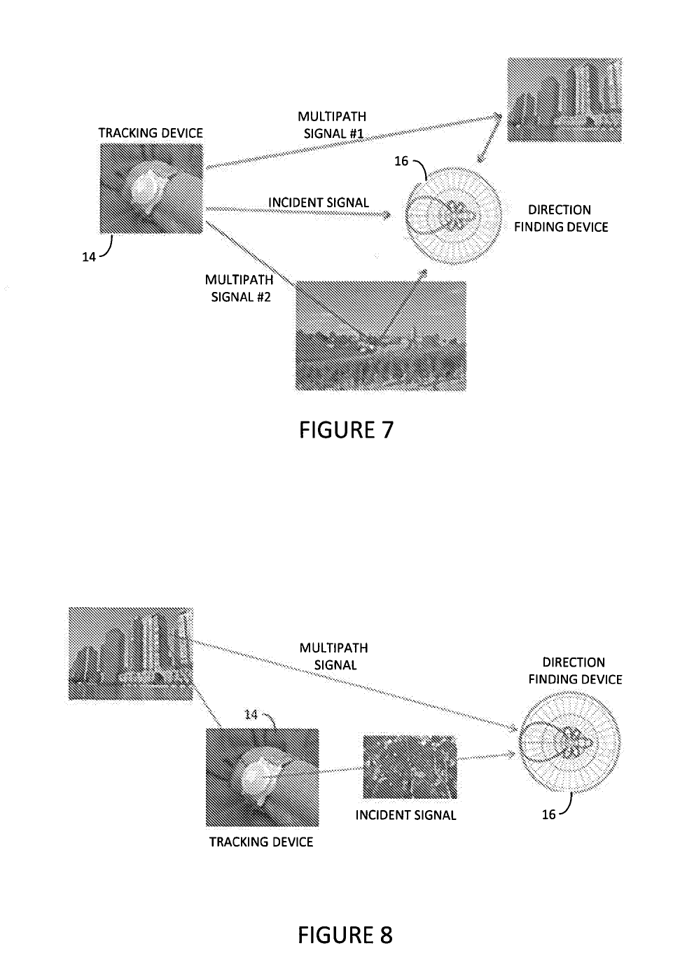

FIG. 7 illustrates operation of the DF device in a multipath environment.

FIG. 8 illustrates operation of the DF device in another multipath environment.

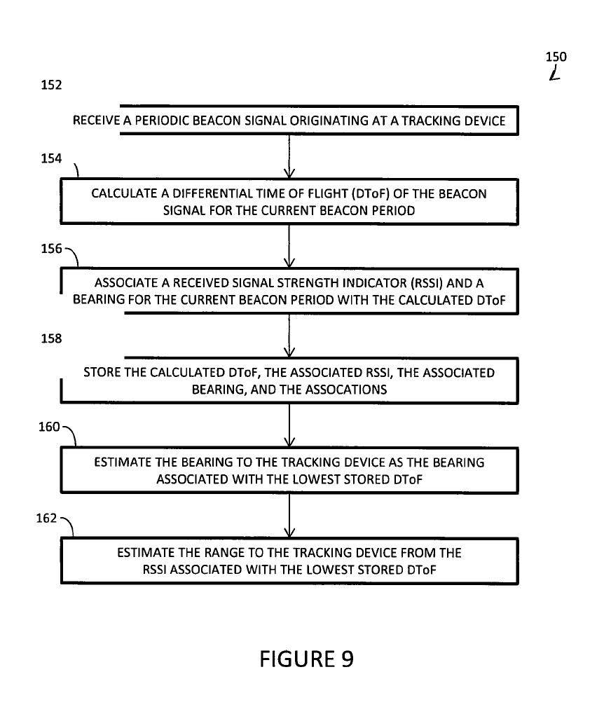

FIG. 9 illustrates a method for tracking a tracking device using a unidirectional beacon.

To resolve direction and range in autonomous direction finding, the present application describes a unidirectional tracking system that combines the use of a radio frequency (RF) beacon transmitter on the object to be tracked with a direction finding (DF) device. The DF device uses differential time of flight (DToF), received signal strength indicator (RSSI), an electronic compass, and a directional antenna to provide a bearing and range estimate to the object. The tracking system reduces tracking problems caused by multipath environments by determining the bearing from the signal with the shortest time of flight (ToF), and therefore the least reflections. This results in a best estimate for the shortest path to the object and eliminates the need for bi-directional communications. This allows the DF device to achieve the greatest link budget and allows the DF device to operate at ranges where bi-directional communications are not possible.

The tracking system is, in one embodiment, used in tracking Alzheimer's patients that wander outside their defined safe zones or geographical fences. A safe zone is an area in which the patient is allowed to travel without generating an alert. While the tracking system finds particular application in tracking Alzheimer's patients, it has broader applicability to tracking any object or person. For example, the tracking system can be used to track goods, merchandise, materials or vehicles. As another example, the tracking system can be used as a real-time locating system (RTLS). As yet another example, the tracking system can be used to locate emergency services in a building. This would be useful for emergency workers, such as firefighters.

With reference to FIG. 1, a tracking system 10 according to the present application is illustrated. The system 10 can be used in any environment 12, such as an open field, urban canyon or indoor environment. However, the system 10 finds particular application where global positioning system (GPS), WiFi, and cellular tracking are unavailable.

The system 10 includes a tracking device 14 that transmits a periodic RF beacon signal when out of a defined safe zone or geographical fence. For example, the beacon signal can be transmitted when GPS, WiFi or cellular tracking are unavailable. The tracking device 14 is typically worn on the wrist of a user to be tracked, such as an Alzheimer's patients, but it can be associated with the user's location in other ways. For example, the tracking device 14 can be placed within a pocket of the user. The system 10 further includes a DF device 16 that receives the beacon signal from the tracking device 14 and estimates the bearing and the range of the tracking device 14.

With reference to FIG. 2, the beacon signal can be a continuous wave (CW) burst or, as illustrated, a packet comprising a frequency modulated preamble, a synchronization word and a unique identifier (ID). The preamble is used to synchronize the receiver bit/byte boundaries of the DF device 16 to the beacon signal. The synchronization word is used to filter wanted from unwanted messages and to synchronize the receiver bit/byte boundaries to the beacon signal. The unique ID is a number of characters used to uniquely identify the user. The unique ID is, in one embodiment, six bytes, but it can be as low as a byte in environments with few users. In some instances, one or more of the preamble, the synchronization word, and the unique ID are further used to increase the frame length (i.e., the packet size), which advantageously improves DToF accuracy.

Additional fields can be added to the packet. For example, the packet can include a data payload, which can include telemetry data as a first approximation to last known position. Telemetry data can include elevation, GPS coordinates, WiFi media access control (MAC) addresses, and time. The WiFi MAC addresses could be used by a location service to locate routers and generate co-ordinates. The telemetry data could result in a significant reduction in search time by estimating a maximum error based on speed of wandering person. As another example, the packet can include a cyclic redundancy check (CRC). Advantageously, additional fields extend the length of the packet, which improves DToF accuracy.

In some instances, the unique ID and/or the data payload are combined with data whitening. Data whitening is used to randomize the unique ID and/or the data payload to remove any direct current (DC) offsets and distribute power evenly over the occupied bandwidth. Data whitening is performed by applying a decorrelation transformation to the data to minimize the autocorrelation within the representative signal. Further, in some instances, a Gold code is used to uniquely identify the user instead of using the unique ID. The Gold code is one of several Gold codes of a set. The Gold codes of the set are assigned to different users and are binary sequences (e.g., orthogonal sequences) with bounded small cross-correlations. The Gold codes are used in combination with a modulation scheme, such as quadrature phase-shift keying (QPSK), and allow multiple users to occupy the same channel simultaneously by reducing interference between transmitting devices. However, this adds complexity because it requires synchronization between the transmitting devices.

With reference to FIG. 3, the tracking device 14 is typically worn like a watch, band, or bracelet by a patient, such as an Alzheimer's patient, to be tracked. The tracking device 14 is powered by a battery 18, typically a rechargeable battery, and activated by an activation signal generated by activation circuitry 20. The activation circuitry 20 can generate the activation signal in response to the patient triggering a switch or button of the tracking device 14. Further, the activation circuitry 20 can generate the activation signal in response to the tracking device 14 leaving a defined safe zone or geographical fence. This can, for example, be determined by a sensor or network controller communicating with a network, such as a cellular network or a WiFi network. Alternatively, this can be determined based on GPS coordinates and time stamps. The boundary of the safe zone can include transmitters that wake the tracking device 14 Gold codes allow multiple users to occupy the same channel simultaneously by reducing interference between transmitting devices from a sleep mode.

After activation, a controller 22, such as a microcontroller, employs a transmitter 24 connected to an antenna 26 to transmit the periodic RF beacon signal to the DF device 16. The transmitter 24 can transmit, for example, in the Industrial, Scientific and Medical (ISM) band. The antenna 26 is any suitable planar or three dimensional structure that provides typically omni-directional performance within the enclosure dimensions of the tracking device 14. The beacon signal repeatedly describes a packet comprised of a preamble, a synchronization word, a unique ID, an optional data payload, and an optional CRC. In some instances, the tracking device 14 further includes a pressure sensor 28 to allow calculation of differential pressure and therefore differential elevation. This additional data can be sent in the data payload of the packet. Other data can be included in the data payload, such as the last WiFi MAC address or the last GPS coordinate.

To maintain time, the controller 22 receives a reference or clock signal from an oscillator 30. The oscillator 30 is suitably a high stability temperature-compensated crystal oscillator (TCXO) with a frequency/temperature characteristic of around 0.1 parts per million (ppm) per 10 degrees Celsius (° C.). Alternatively, the reference or clock signal can be received from a GPS signal or a WWV signal.

With reference to FIG. 4, the DF device 16 is typically hand held. Further, the DF device 16 is typically powered by a battery 32, such as a rechargeable battery, and activated by activation circuitry 34. The activation circuitry 34 can activate the DF device 16 in response to a caregiver triggering a switch or button of the DF device 16. A directional antenna 36 is connected to a down converter 38, which provides an intermediate frequency (IF) signal to a software defined radio (SDR) 40 through an analog to digital (A/D) converter 42. The SDR 40 is typically implemented in a field-programmable gate array (FPGA) or digital signal processor (DSP).

When the DF device 16 is activated, the SDR 40 receives modulated data from the A/D converter 42, as well as bearing data from an electronic compass 44. Further, the SDR 40 receives a reference signal from an oscillator 46 to maintain time. As with the tracking device 14, the oscillator 46 is suitably a high stability TCXO with a frequency/temperature characteristic of around 0.1 ppm per 10° C. In another instance, a GPS signal, or a WWV signal, could be used to generate the reference signal for superior timing precision. Using this data, the SDR 40 estimates the bearing and the range to the tracking device 14 and displays the estimates on a display device 48.

Bearing and range are continuously estimated at the beacon rate as a user sweeps the DF device 16 back and forth. At the beginning of a beacon period, the bearing of the DF device 16 is read from the electronic compass 44. Further, the first instance of the beacon packet for the beacon period is selected, and the instance of the beacon packet with the largest RSSI is selected. Multiple instances of the beacon packet can be received when the beacon signal arrives at the DF device 16 through multiple different transmission paths (e.g., due to reflection and refraction). DToF is then calculated for the first instance. A beacon record comprising the bearing, the DToF and the largest RSSI are then stored in a memory 50 of the SDR 40, the beacon records of which are periodically cleared. Alternatively, the RSSI of the composite beacon signal can be employed instead of the largest RSSI of the instances.

Typically, in response to updating the memory 50 with a beacon record, the bearing and range estimates to the tracking device 14 are updated and displayed. In that regard, the beacon record of the memory 50 with the lowest DToF is selected. The bearing of the selected beacon record is then used as the estimate to the tracking device 14. Further, the range estimate to the tracking device 14 is calculated from the RSSI of the selected beacon record. The estimates are then displayed on the display device 48.

With reference to FIG. 5, a more detailed view of the DF device 16 that expands on the embodiment of FIG. 4 is provided. During operation, a user of the DF device 16 sweeps the DF device 16 from side to side until enough data is acquired to estimate the bearing and therefore and therefore identify the general direction of the tracking device 14 as displayed by the DF device 16 on the display device 48. Initially, the user may have to sweep the DF device 360 degrees in a circle before the DF device 16 can display the general direction of the tracking device 14. If no signal is acquired then it will be necessary to continue searing from other locations.

As the user sweeps the DF device 16, the directional antenna 36 selectively receives signals, such as the beacon signal. Selection is performed based on the direction the user points the directional antenna 36 in. In a multipath environment, multiple instances of a signal, such as the beacon signal, are typically received at varying times due to the signal traveling along multiple transmission paths. The down converter 38 down converts the received signals to low frequency signals (often called zero IF signals) suitable for direct conversion to baseband. The down converted signals are sampled by the A/D converter 42 and the data r_{mod}(t) is passed to at least one correlating receiver 52. r_{mod}(t) represents the sampled signal values as a function of time t. Typically, the at least one correlating receiver 52 is part of the SDR 40. Further, the at least one correlating receiver 52 is typically similar to a rake receiver. However, the outputs from the individual figures are not only combined using maximum combining ratio but also used individually to determine ToF and RSSI, as illustrated.

The at least one correlating receiver 52 demodulates received signals to identify the wanted beacon signal. The wanted beacon signal is identified by the unique ID and the synchronize word 54 of the tracking device 14, typically stored in the memory 50. Each instance of the beacon signal for the current beacon period is then assigned to a finger (i.e., sub-receiver), which independently decodes the assigned instance. Subsequently, the outputs of all of the fingers are combined to make use of the different transmission characteristics of the different transmission paths. Advantageously, the outputs of all of the fingers are used to identify the instance of the beacon signal with the lowest ToF and the instance of the beacon signal with the highest RSSI. Further, the composite beacon signal can provide a greater signal to noise ratio (SNR) and a better operating range (to show that the target has been identified) than any individual instance of the beacon signal. Further, as an alternative to employing multiple fingers, the correlating receiver could also correlate the signal across a sliding time window to find the earliest time of arrival by looking for the earliest time of correlation.

In some instances, the at least one correlating receiver 52 carries out the foregoing with a demodulator 56, a finger manager 58, a channel estimator 60, and a maximum ratio combiner 62. The demodulator 56 receives and demodulates the down converted modulated data. The output of the demodulator r_{demod}(t) then passes to the finger manager 58 to select the wanted beacon signal and assign each instance r(t−Fᵢ) of the beacon signal for the current beacon period to a finger. r_{demod}(t) represents the demodulated data as a function of time t, and r(t-Fᵢ) represents the demodulated data as a function of time t for an instance i. Fᵢ is a temporal offset from the beginning of the beacon period or the first instance to instance i of the beacon signal, where i ranges from 1 to n and n is the number of instances.

To identify the various instances of the beacon signal and the corresponding temporal offsets, the finger manager 58 includes a correlator 64, such as the illustrated matched filter, to correlate the instances of the beacon signal. A correlator correlates a template signal (i.e., a known signal) with an unknown signal to detect the presence of the template signal in the unknown signal. For example, the unknown signals are time shifted into alignment with the known signal. Typically, the first instance of the beacon signal detected by the finger manager 58 is used as the known signal.

Subsequently, the channel estimator 60 assigns a time stamp Ts and an amplitude A to each finger. Timing is derived from the oscillator 46, such as a TCXO, which generators a reference signal used by a system clock generator 66, typically of the SDR 40, to generate a system clock, such as a 100 megahertz (MHz) system clock. Alternatively, the reference signal can be derived from a GPS signal or a WWV signal. The reference signal and the system clock are used by the down converter 38 and the A/D converter 42, respectively. Further, the system clock is used by a time stamp generator 68, typically of the SDR 40, to generate a rolling time stamp. Typically, the time stamp is 32 bits in length. Assuming the time stamp has a resolution of 10 nanoseconds (ns), which is equivalent to about a 3 meter (m) accuracy at a 900 MHz carrier frequency, then the 32 bit length would provide a range of 42 seconds (i.e., 1E-8×2³²). Thus, the time stamp resolution is several orders of magnitude greater than a sweep of the DF device 16.

The maximum ratio combiner 62 combines the output of the channel estimator 60 using maximal-ratio combining (MRC) to provide a composite beacon signal r(t)_{MCR} with the best SNR. MRC typically includes: 1) adding all the instances of the beacon signal together; 2) adjusting the gain of each instance to make the gain proportional the root mean square (RMS) signal level and inversely proportional to the mean square noise level of the instance; and 3) using different proportionality constants for each instance. The composite beacon signal can be output to allow use of a data payload including, for example, telemetry data, such as elevation or GPS coordinates. Further, a signal indicating whether the transmitting device 14 is detected from the composite beacon signal can be displayed on the display device 48.

With further reference to FIG. 6, a range and bearing estimator 70, typically of the SDR 40, receives the individual instances of the beacon signal, as well as the time stamps and the amplitudes assigned to the instances, from the at least one correlating receiver 52. The range and bearing estimator 70 then estimates a range and a bearing to the tracking device 14. The instance with the earliest beacon packet is selected 72, and the instance with highest RSSI value is selected 74. The instance with the lowest ToF is the best estimate for the shortest path to the tracking device 14, and the instance with the highest RSSI is the best estimate for the range to the tracking device 14. DToF is then calculated 76 by subtracting the time stamp Ts of the earliest beacon packet from the time of a beacon synchronization pulse indicating the start of the current beacon period.

A synchronizer 78 generates the beacon synchronization pulse by dynamically updating 80 an estimate of the beacon period, including the bounds and the length. The estimate is initialized 82 to a predetermined length, such as 100 milliseconds (ms), with boundaries extending from the time of initialization to the time of initialization plus the predetermined length. Typically, the estimate is updated using observations of the instances of the beacon signal, such as the temporal offsets, the amplitudes and the time stamps. The update can be performed at the beacon rate based on the observations. Further, the update can be performed using the time difference between the instances as input to a Kalman filter, which provides a statistical estimate of the beacon period. From the updated estimate, the beacon synchronization pulse is generated 84 at the start of the estimated beacon period.

The beacon rate and the beacon period being observed are defined by the tracking device 14. It's necessary to estimate the beacon period from observation because the beacon rate and the beacon period may vary over time due to, for example, temperature. The beacon period and the beacon rate employed by the tracking device 14 are selected so the time to traverse the maximum path length of the beacon signal plus the time to transmit the length of the beacon packet is less than half the beacon period. Put another way, the beacon period and the beacon rate employed by the tracking device 14 are selected so the maximum ToF of the beacon signal is less than half the beacon period. Selecting the beacon period and the beacon rate in this manner advantageously minimizes the likelihood of instances of the beacon signal being dispersed across consecutive beacon period boundaries.

The bearing of the DF device 16 at the time of the beacon synchronization pulse is read 86. The bearing of the DF device 16 (e.g., a value ranging from 0 to 360 degrees) is suitably determined from the electronic compass 44, such as a magnetometer, and read synchronously with correlated beacon packets at the beacon rate. Beacon data for the current beacon period is then employed to selectively update 88 a beacon index (BIN) 90, typically stored in the memory 50. The beacon data includes the bearing, the DToF of the earliest packet, and the highest RSSI. The BIN 90 stores beacon data for various beacon periods indexed based on a plurality of sectors. The sectors are non-overlapping, like-sized ranges of bearings that collectively span the range of possible bearings. For example, the sectors could span from 0 degrees to 360 degrees in 30 degree increments.

In determining whether to update the BIN 90, beacon data in the BIN 90 is selected 92 for the sector to which the bearing belongs. For example, supposing the bearing is 25 degrees, the beacon data for a sector spanning 0 degrees to 30 degrees is selected. A determination 94 is then made as to whether the DToF of the determined beacon data is greater than the current DToF, and/or a determination 96 is made as to whether the RSSI of the selected beacon data is less than the current RSSI. If the current RSSI is more and/or the current DToF is less, the updating 88 is performed and the current beacon data replaces the selected beacon data in the BIN 90. Continuing with the above example, this would entail overwriting the beacon data for the sector spanning 0 degrees to 30 degrees with the current beacon data. If the current RSSI is less or the current DToF is more, the updating 88 is not performed.

Typically, the BIN 90 is emptied 98 at a predetermined refresh rate, such as 10 seconds, to remove old beacon data. However, other approaches can be employed to remove old beacon data. For example, a rolling window can be used for each sector. That is to say, the beacon data for each sector is removed at a predetermined refresh period, such as 10 seconds, from the last update to the sector. This is performed independent from the other sectors and rolling in the sense that the counter for the predetermined period of time is reset every time the sector is updated. As should be appreciated, the time stamp resolution is several orders of magnitude greater than the refresh rate.

In the foregoing manner, the BIN 90 is continuously updated as the user of the DF device 16 walks and sweeps the DF device 16. This advantageously accounts for changes in the location of the tracking device 14 or the DF device 16. Using the BIN 90, a bearing and a range of the tracking device 14 are estimated and displayed to the user on the display device 48. Further, in some instances, the current bearing and/or the moving average bearing read from the electronic compass 44 are further displayed. The moving average bearing is generated by a moving average calculator 100 as the average of the last predetermined number of bearing readings 102. For example, the moving average bearing could be the average bearing over the last five readings. By displaying the current bearing with the estimated bearing to the tracking device 14, the user can intelligently walk and sweep the DF device 16 towards the tracking device 14.

To complete the estimate and display of the bearing and the range to the tracking device 14, the beacon data for the sector with the lowest DToF is selected 104 from the BIN 90. The bearing of the selected beacon data is then displayed. Further, the range is estimated 106 from the RSSI of the selected beacon data and displayed. As the user gets closer to the tracking device 16, the estimated range will become successively smaller but will not provide an absolute value as seen in true ranging systems where precise distance is a necessity. Advantageously, determining the bearing and the range in this manner eliminates the longest transmission paths. Further, false transmission paths are eliminated and the range accuracy is improved.

In some instances, the range estimate can be refined with the known difference in time between the DToF of the first instance and the DToF of the instance to which the RSSI corresponds. In such instances, the beacon data for each sector further includes this additional DToF of the instance to which the RSSI corresponds. Advantageously, refining the range in this manner allows for a more accurate estimate. Further, in some instances, the beacon data of the BIN 90 includes the current GPS location of the tracking data, as included in the data payload. The payload data can, for example, be extracted from the composite beacon signal. In such instances, statistical analysis on the beacon data of the BIN 90 can be employed to eliminate historically false transmission paths, thereby improving the bearing and range estimates.

The ability of the DF device 16 to discriminate between different DToFs is dependent upon a number of discriminatory factors. The discriminatory factors include: 1) the accuracy of the electronic compass 44, typically +/−15 degrees; 2) the SNR of the wanted beacon at the receiver; 3) the precision of the transmitter 24 of the tracking device 14 periodically repeating the beacon signal within required accuracy; and 4) the ratio of power gain between the front and rear of the directional antenna 36, as well as the beam bandwidth and the gain of the directional antenna 36. A high ratio of power gain between the front and rear of the directional antenna 36 reduces the probability of inadvertently receiving a signal from rear of the antenna 36 resulting in a 180 degree bearing error. Further, the system range improves with greater antenna gain and the optimum beam width is a function of the desired sweep rate, bearing accuracy, and required gain.

The discriminatory factors further include the precision of the oscillator 46 used to derive a relative time stamp for each received beacon transmission correlated in the at least one correlating receiver 52. Suppose a maximum of 4 seconds between two different bearings in the sweep and a carrier frequency of 1 gigahertz (GHz). If the maximum allowed error due to a change of temperature is 10 meters (e.g., in close proximity to the tracking device), then the maximum system error due to the stability of the oscillators 30, 46 is on the order of 1.2E-16 m per period. Further, if an error due to drift of at most 6 m is desired, the maximum temperature difference in those 4 seconds can be calculated. The time to travel is 20 nanoseconds (ns) so the temperature should not change more 2° C. in 4 seconds.

Although shown as discreet components, it is to be understood that one or more of the system clock generator 66, the time stamp generator 68, the at least one correlating receiver 52, the synchronizer 78, the range and bearing estimator 70 and the moving average calculator 100 can be components of the SDR 40. For example, in some instances, the at least one correlating receiver 52 is included with the SDR 40 and implemented using digital signal processing techniques either in software or coded in hardware using an FPGA.

Further, although the BIN 90 stored bearings read from the electronic compass 44, it is to be appreciated that differential angles of arrival (DAoAs) can be employed instead. DAoAs can be calculated by combining DToA with bearings. Hence, instead of storing bearing in the BIN 90, using bearing to define the sector boundaries of the BIN 90, and displaying bearing on the display device 48, DAoAs are stored in the BIN 90, used to define the sector boundaries of the BIN 90, and displayed on the display device 48 as the bearing estimate.

With reference to FIG. 7, an example of a multipath environment illustrates operation of the DF device 16. The tracking device 14, illustrated as worn on a patient's wrist, transmits a beacon signal. Further, the DF device 16, represented by a polar plot of the directional antenna 36, is swept clockwise starting at 300 degrees and observes three instances of the beacon signal, one of which is incident and two of which are multipath. The incident signal is identified as having both the shortest ToF and the highest RSSI relative to the multipath signals. Therefore, the incident signal is used for both determining the bearing and the range to the tracking device 14. As above, to minimize the likelihood of an instance of the beacon signal being dispersed across consecutive beacon period boundaries, the ToF must be less than half the beacon period.

With reference to FIG. 8, another example of a multipath environment illustrates operation of the DF device 16. The tracking device 14 transmits a beacon signal. The DF device 16, represented by a polar plot of the directional antenna 36, is then swept clock wise starting at 350 degrees and observes two instances of the beacon signal, one of which is incident and one of which is multipath. The incident signal has a low RSSI and is, for example, attenuated by foliage. The multipath signal has a high RSSI and is, for example, reflected by a building behind the tracking device 14. The incident signal is identified as having the shortest ToF, and the multipath signal is identified as having the highest RSSI. Typically, the incident signal occupies the first finger of the at least one correlating receiver 52 and the multipath signal occupies a finger that corresponds to the additional delay of the reflection. The DToF is then calculated from the incident signal and used in determining the bearing to follow in locating the tracking device 14. Further, the multipath signal with the highest RSSI is used for estimating the range to the tracking device 14.

In the multipath environment of FIG. 7, a conventional receiver could have been employed since the incident signal had both the shortest ToF and the highest RSSI. However, in the multipath environment of FIG. 8, a conventional receiver would have led to problems locating the tracking device 14 since the incident signal had the shortest ToF but not the highest RSSI. Hence, FIG. 8 illustrates a case where a correlating receiver is preferable over a conventional receiver. The case of FIG. 8 will be common for indoor applications where numerous different transmission paths of a signal are likely.

The range accuracy of the system 10 can be defined using the Cramer-Rao Lower Bound (CRB). Namely, the CRB can be used to derive a link between SNR and bandwidth to give a bound on ranging performance. For example, a lower bound for the variance of a range estimate \hat{r} can be calculated as follows:

$${σ}_{\hat{r}}^{2} \geq \frac{{c}^{2}}{{( 2 π B )}^{2} ( {E}_{s} / {N}_{0} )} ( 1 + \frac{1}{{E}_{s} / {N}_{0}} ) ,$$

where σ_{\hat{r}}² is the variance of the range estimate, c is the speed of light, B is the occupied signal bandwidth in Hertz, E_{S}/N₀ is the signal energy to noise density ratio. E_{S}/N₀ is related to SNR as follows:

$$\frac{{E}_{s}}{{N}_{0}} = {t}_{s} B \cdot SNR ,$$

where t_{S} is the signal duration during which the bandwidth B is occupied.

As should be appreciated, a number of the variables in the CRB are fixed by internationally available frequency spectrum and the sensitivity needed to meet range requirements. Further, it should be appreciated that N₀ and t_{S} can vary depending upon whether the SNR at the input of the at least one correlating receiver 52 is high or low. To illustrate, assume the 900 MHz band of the United States (US) (Federal Communications Commission (FCC) part 15.249) is employed. For a high SNR at the input of the at least one correlating receiver 52 when the DF device 16 is in close range to the tracking device 14, the Cramer-Rao root mean square (RMS) accuracy is estimated to be 0.6 meters (m). When the system 10 is at maximum range between the tracking device 14 and the DF device 16, the SNR is the power of the modulated carrier signal divided by the receiver noise. The maximum range is expected to be on the order of 1000's of meters. Under these conditions, the Cramer-Rao RMS accuracy is estimated to be 74.2 m. Thus, as the user gets closer to the tracking device 14, the DToF accuracy improves from 74.2 m at the maximum range to 0.6 m.

To improve the ranging accuracy, the size of beacon packets can be increased, since this increases t_{S}. For example, the synchronization word and/or the payload data can be used to increase the beacon packet. However, t_{S} may be limited by international duty cycle restrictions. Further, increasing the packet size increases power draw. Since the tracking device 14 is portable, a balancing between accuracy and battery life must be drawn.

The foregoing discussion pertained to unidirectional communication between the tracking device 14 and the DF device 16. However, in some instances, bidirectional communication can be employed in conjunction with OR excluding uni-directional ToF. In such instances, the DF device 16 transmits the beacon signal using the unique ID of the DF device 16. Further, the TD acts as a transponder to retransmit the received beacon signal with the unique ID assigned to the tracking device 14. The DF device 16 receives the retransmitted beacon signal and carries out the foregoing process using absolute ToF in place of DToF to populate the BIN 90 with bearing and ToF. RSSI need not be considered anymore. The BIN 90 is then analyzed to estimate the range and the bearing of the tracking device 14. The estimated bearing of the tracking device 14 is the bearing corresponding to the shortest ToF in the BIN 90. The estimated range of the tracking device 14 is calculated from the shortest ToF in the BIN 90. The use of bidirectional communication would result in an absolute range and bearing estimate. However, this would come at the expense of a more complex system with a shorter range.

With reference to FIG. 9, a method 150 for estimating the range and the bearing of the tracking device 14 is provided. The method 150 is performed by the DF device 16, typically by the SDR 40 of the DF device 16, and includes receiving 152 a periodic beacon signal transmitted from (i.e., originating at) the tracking device 14 with a directional antenna 36 oriented at multiple bearings over time. The directional antenna 36 is suitably oriented at the multiple bearings over time by sweeping the directional antenna 36 from side to side. This sweeping can be automated or performed manually by a user of the DF device 16.

At an estimated beacon rate, the DToF of the beacon signal during the current beacon period is calculated 154. As discussed above, the synchronizer 78 estimates the beacon period and the beacon rate through observation of the received beacon signal. The DToF is calculated as the difference between the time of arrival (ToA) of the beacon packet for the current beacon period and the estimated start of the current beacon period. Although DToF is described herein, it is to be understood that absolute ToF can also be employed, as described in greater detail above.

Also at the estimated beacon rate, the calculated DToF is associated 156 with the RSSI of the beacon signal during the current beacon period and with the bearing of the directional antenna 36 read from an electronic compass 44 during the current beacon period, typically at the estimated start of the current beacon period. The DToF, the associated bearing, the associated RSSI, and the associations are then stored 158 in the BIN 90. The BIN 90 can be periodically cleared. As discussed above, the storing can be selective in some instances. For example, the storing may only be performed if the associated RSSI is greater than an RSSI at a sector of the BIN 90 corresponding to the associated bearing. As another example, the storing may only be performed if the calculated DToF is less than a DToF at a sector of the BIN 90 corresponding to the associated bearing.

Using the BIN 90, typically at the estimated beacon rate or in response to an update to the BIN 90, the bearing and the range to the tracking device 14 are estimated 160, 162. The bearing to the tracking device 14 is estimated 160 as the bearing associated with the lowest DToF in the BIN 90. The range to the tracking device 14 is estimated 162 from the RSSI associated with the lowest DToF in the BIN 90.

In some instances, such as in multipath environments, multiple instances of the beacon signal are simultaneously received 152 during a current beacon period. Each of the instances corresponds to a different transmission path. As noted above, multiple transmission paths can arise do to, for example, reflection and refraction of the beacon signal off terrestrial objects. For example, one instance can correspond to an incident signal and another instance can correspond to a multipath signal reflected off a building. Where multiple instances are received, the foregoing actions are the same except as follows. The instances are correlated by at least one correlating receiver 52, similar to a rake receiver, to identify the first received instance. Further, the DToF is calculated 154 from the first instances received during the current beacon period. Even more, the DToF is associated 156 with the highest RSSI of the instances. This advantageously allows improved operation of the DF device 16 in a multipath environment similar to that described in FIG. 8.

In view of the foregoing, relative to known tracking systems employing RSSI and/or Doppler shift, the tracking system 10 of the present application reduces the probability of following a wrong beacon signal in a multipath environment where it is difficult to differentiate between incident and multipath signals. This is accomplished by estimating range based on the strongest received RSSI and independent of the signal providing bearing. Further, a correlator type receiver, similar to a rake receiver, estimates bearing and range more effectively in multipath environments.

Further, the tracking system 10 of the present application provides a simpler, more power efficient design compared to known tracking systems employing an absolute measurement of ToF in which the DF device 16 provides the source of signal and the TD 14 acts as a transponder. In contrast to the tracking system 10 of the present application, these known tracking systems are more complex due to the need to: 1) synchronize the TD 14 to the DF device 16 to minimize receive current consumption; and 2) allow synchronization between the received beacon and the transmitted reply.

Even more, the tracking system 10 of the present application improves range over real-time locating systems (RTLS) that employ low gain omnidirectional type antennas by using a DF device 16 with a directional antenna 36. A predominantly single Omni-directional antenna, or optionally augmented with an additional Omni-directional diversity antenna, allows for maximum total radiated power (TRP) and therefore improved range. Further, the directional antenna 36 simplifies the design of the DF device 16. Known systems require complex rotating antennas (e.g., like radar) or switched antenna arrays (e.g., Doppler shift systems).

Moreover, relative to known systems employing absolute measurement of ToF and bi-directional communication protocols with asymmetric forward and reverse link budget (i.e., inefficient receive antennas on the TD 14), the tracking system 10 of the present application improves range by using a unidirectional communication protocol.

As used herein, a memory includes any device or system storing data, such as a random access memory (RAM) or a read-only memory (ROM). Further, as used herein, a processor includes any device or system processing input device to produce output data, such as a microprocessor, a microcontroller, a graphic processing unit (GPU), an application-specific integrated circuit (ASIC), a FPGA, and the like; a controller includes any device or system controlling another device or system, and typically includes at least one processor; a user input device includes any device, such as a mouse or keyboard, allowing a user of the user input device to provide input to another device or system; and a display device includes any device for displaying data, such as a liquid crystal display (LCD) or a light emitting diode (LED) display.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A system for tracking a tracking device, said system comprising:
a radio frequency (RF) receiver configured to receive a periodic beacon signal originating at the tracking device, the periodic beacon signal received with a directional antenna at multiple bearings over time; and
an estimator configured to estimate a bearing to the tracking device as the bearing of the multiple bearings in which a time of flight (ToF) of the periodic beacon signal is lowest.

2. The system according to claim 1, wherein the RF receiver is further configured to:
simultaneously receive multiple instances of the periodic beacon signal with the directional antenna at a bearing of the multiple bearings; and
correlate the instances to identify which of the instances has a lowest ToF, the lowest ToF being the ToF of the periodic beacon signal at the bearing of the multiple instances.

3. (canceled)

4. The system according to claim 2, wherein the estimator is further configured to:
estimate a range to the tracking device from a received signal strength indicator (RSSI) of the periodic beacon signal at the estimated bearing, the RSSI of the periodic beacon signal at the bearing of the instances being a highest RSSI of the instances.

5. The system according claim 1,
wherein the beacon signal is received using spread spectrum techniques that allow for higher equivalent isotropically radiated power (EIRP) by spreading power.

6. (canceled)

7. The system according to claim 1, further including:
an electronic compass configured to determine the multiple bearings of the antenna.

8. The system according to claim 1,
wherein the ToF of the periodic beacon signal is differential ToF (DToF), and wherein the estimated bearing is determined from DToF.

9. The system according to claim 1, wherein the estimator is further configured to:
calculate the ToF of the periodic beacon signal as the difference between a time of arrival (ToA) of a packet of the beacon signal and an estimated start of a corresponding beacon period.

10. The system according claim 1, further including:
a temperature-compensated crystal oscillator (TCXO) configured to generated time stamps used to calculate the ToF of the periodic beacon signal.

11. A method for tracking a tracking device, said method comprising:
receiving a periodic beacon signal originating at the tracking device with a directional antenna at multiple bearings over time; and
estimating a bearing to the tracking device as the bearing of the multiple bearings in which a time of flight (ToF) of the periodic beacon signal is lowest.

12. The method according to claim 11, further including:
simultaneously receiving multiple instances of the periodic beacon signal with the directional antenna at a bearing of the multiple bearings; and
correlating the instances to identify which of the instances has a lowest ToF, the lowest ToF being the ToF of the periodic beacon signal at the bearing of the multiple instances.

13. (canceled)

14. The method according to either claim 12, further including:
estimating a range to the tracking device from a received signal strength indicator (RSSI) of the periodic beacon signal at the estimated bearing, the RSSI of the periodic beacon signal at the bearing of the instances being a highest RSSI of the instances.

15. The method according to claim 11, further including:
receiving the periodic beacon signal by a correlating receiver.

16. The method according to claim 11, further including:
determining the multiple bearings of the antenna from an electronic compass.

17. The method according to claim 11, further including:
calculating the time of flight (ToF) of the periodic beacon signal at the multiple bearings as differential ToF (DToF), wherein the estimated bearing is determined from DToF.

18. The method according to claim 11, further including:
calculating the ToF of the periodic beacon signal as the difference between a time of arrival (ToA) of a packet of the beacon signal and an estimated start of a corresponding beacon period.

19. A direction finding device for tracking a tracking device, said device comprising:
a correlating radio frequency (RF) receiver configured to receive a periodic beacon signal originating at the tracking device, wherein the periodic beacon signal is received with a directional antenna oriented at multiple bearing orientations over time, and wherein multiple instances of the periodic beacon signal are simultaneously received at one of the antenna bearing orientations; and
a processor configured to select the bearing orientation of the multiple bearing orientations associated with a lowest time of flight (ToF) of the periodic beacon signal, wherein the ToF of the periodic beacon signal at the bearing orientation of the instances is a lowest ToF of the instances; and
a display device configured to display the selected bearing orientation to indicate a direction of the tracking device.

20. The device according to claim 19, wherein the processor is further configured to:
time shift the multiple instances to bring the multiple instances into temporal alignment and combine the multiple instances into a combined signal;
determine a distance to the tracking device from a strength of the combined signal; and
control the display device to display the determined distance.
